(19) United States
(12) Patent Application Publication
(10) Pub. No.: US 2018/0063891 A1
(43) Pub. Date: Mar. 1, 2018

(54) INDUCTION HEATING DEVICE

(71) Applicant: Panasonic Intellectual Property Management Co., Ltd., Osaka (JP)

(72) Inventors: Makoto IMAI, Shiga (JP); Atsushi FUJITA, Shiga (JP); Takayuki HIROKAWA, Shiga (JP)

(21) Appl. No.: 15/669,125

(22) Filed: Aug. 4, 2017

(30) Foreign Application Priority Data
Aug. 23, 2016 (JP) 2016-162348

(51) Int. Cl. H05B 6/04; H02M 5/458

(52) U.S. Cl. CPC H05B 6/04; H02M 5/4585

(57) ABSTRACT

A resonant circuit in an inverter includes a first resonant circuit configured with a heating coil and a first resonant capacitor connected in series to the heating coil, a second resonant circuit configured with the first resonant circuit and a second resonant capacitor connected in parallel to the first resonant circuit, and a resonance choke coil connected in series to the second resonant circuit. The resonant circuit is configured so that impedance of the heating coil and the first resonant capacitor is set to be close to impedance of the second resonant capacitor, at a frequency of a current flowing through the heating coil. Thus, an object to be heated can be efficiently induction-heated without an increase in a current flowing through the switching element.

### RELATED APPLICATIONS

This application claims priority under 35 U.S.C. § 119 to Japanese Patent Application No. 2016-162348 filed on Aug. 23, 2016, the entire content of which is hereby incorporated by reference.

### BACKGROUND

### 1. Technical Field

The present disclosure relates to an induction heating device including a plurality of heaters each of which heats an object to be heated on a top plate by using an inverter control device that converts a direct current (DC) into an alternating current (AC).

### 2. Description of the Related Art

Conventionally, for example, Unexamined Japanese Patent Publication No. 2003-257609 (hereinafter referred to as “PTL 1”) discloses an induction heating device which generates a high-frequency magnetic field by means of a heating coil, and uses eddy currents generated by electromagnetic induction to heat various metal loads including a pot made of aluminum.

The induction heating device described in PTL 1 will be described below with reference to FIG. 4

FIG. 4 is a circuit configuration diagram of the conventional induction heating device described in PTL 1.

The conventional induction heating device includes rectifier circuit 52, first smoothing capacitor 53, second smoothing capacitor 62, choke coil 54, inverter 50, and control circuit 63. The induction heating device is connected to power source 51. Power source 51 is formed of a commercial AC power source and is connected to input terminals of rectifier circuit 52. Output terminals of rectifier circuit 52 are connected to first smoothing capacitor 53.

Inverter 50 is configured with first switching element 55, second switching element 57, heating coil 59, resonant capacitor 60, and the like.

A series-connected body configured with choke coil 54 and second switching element 57 of inverter 50 is connected between the output terminals of rectifier circuit 52. Heating coil 59 is disposed so as to face a pot made of aluminum, which is object 61 to be heated.

A low-potential side terminal of second smoothing capacitor 62 is connected to a negative electrode terminal of rectifier circuit 52. A high-potential side terminal of second smoothing capacitor 62 is connected to a high-potential side terminal (a collector) of first switching element 55 of inverter 50. A low-potential side terminal (an emitter) of first switching element 55 is connected to connecting point C between choke coil 54 and a high-potential side terminal (a collector) of second switching element 57.

A series-connected body configured with heating coil 59 and resonant capacitor 60 of inverter 50 is connected in parallel to second switching element 57.

The conventional induction heating device is configured as described above.

Operation waveforms of respective constituents of the above induction heating device will be described below with reference to FIG. 5.

FIG. 5 is a diagram illustrating operation waveforms of the respective constituents in a circuit configuration of the conventional induction heating device. Note that FIG. 5 illustrates operation waveforms obtained when output of the induction heating device is 2 kW.

Here, part (a) of FIG. 5 illustrates a waveform of current Ic1 flowing through first switching element 55 and first diode 56 illustrated in FIG. 4. Part (b) of FIG. 5 illustrates a waveform of current Ic2 flowing through second switching element 57 and second diode 58. Part (c) of FIG. 5 represents voltage Vce2 generated between the collector and an emitter of second switching element 57. Part (d) of FIG. 5 represents drive voltage Vg1 applied to a gate of first switching element 55, and part (e) of FIG. 5 represents drive voltage Vg2 applied to a gate of second switching element 57. Part (f) of FIG. 5 represents current IL flowing through heating coil 59.

A circuit with a configuration illustrated in FIG. 4 operates as follows.

First, as illustrated in part (e) of FIG. 5, control circuit 63 outputs drive voltage Vg2 of an ON signal to the gate of second switching element 57 in a period from t0 to t1 (corresponding to drive period T2). Thus, a closed circuit formed by second switching element 57 and second diode 58, heating coil 59, and resonant capacitor 60 resonates during drive period T2. Drive period T2 is set to, for example, about 24 μs. That is, drive period T2 is set so that resonant period (1/f) of the pot made of aluminum, which is object 61 to be heated, is about ⅔ (about 16 μs) of drive period T2. Specifically, by adjusting a number of turns of heating coil 59 (40 turns) and capacitance of resonant capacitor 60 (0.04 μF), drive period T2 is set to about 24 μs. At that time, choke coil 54 stores electrostatic energy of first smoothing capacitor 53 as magnetic energy during drive period T2.

Then, control circuit 63 outputs drive voltage Vg2 of an OFF signal to the gate of second switching element 57 to stop driving at time point t1 in a period from a second peak of a resonance current starting to flow through second switching element 57 at t0 to a time when the resonant current becomes zero next time. Note that time point t1 corresponds to timing when current Ic2 flows in a forward direction (a direction from the collector to the emitter) of second switching element 57. Thus, second switching element 57 is turned off, and terminal potential of choke coil 54 connected to the collector of second switching element 57 rises.

Then, when terminal potential of choke coil 54 exceeds potential of second smoothing capacitor 62, magnetic energy stored in choke coil 54 is discharged, and second smoothing capacitor 62 is charged via first diode 56. Thus, second smoothing capacitor 62 is boosted to, for example, about 500 V as illustrated in part (c) of FIG. 5, higher than a peak value (283 V) of DC output voltage Vdc of rectifier circuit 52 illustrated in FIG. 4.

Note that a level of the voltage to be boosted depends on a conduction time (ON time) of second switching element 57. Therefore, as the conduction time is longer, voltage generated at second smoothing capacitor 62 tends to be higher.

That is, resonance of a closed circuit formed by second smoothing capacitor 62, first switching element 55 or first diode 56, heating coil 59, and resonant capacitor 60 increases a voltage level of second smoothing capacitor 62 which functions as a DC power source. At that time, a peak value of the resonance current flowing through first switching element 55 illustrated in part (a) of FIG. 5 is controlled so that the peak value becomes neither zero nor a value close to zero.

Following resonance of first switching element 55, second switching element 57 illustrated in part (b) of FIG. 5 resonates in a closed circuit formed by second switching element 57 or second diode 58, heating coil 59, and resonant capacitor 60. A peak value of a resonance current flowing through second switching element 57 is controlled so that the peak value becomes neither zero nor a value close to zero. As a result, the pot made of aluminum, which is object 61 to be heated, can be induction-heated at high output. Furthermore, heating can be controlled by continuously increasing or decreasing output of heating coil 59.

At that time, as illustrated in part (d) and part (e) of FIG. 5, rest period d1 ranging from t1 to t2 is set. In rest period d1, drive voltages Vg1, Vg2 are not applied to the gates of first switching element 55 and second switching element 57. Then, at time point t2, control circuit 63 outputs drive voltage Vg1 of a drive signal (an ON signal) to the gate of first switching element 55. That is, rest period d1 prevents first switching element 55 and second switching element 57 from conducting (being turned on) simultaneously at time point t1. Then, a resonance path described with reference to part (b) of FIG. 5 is switched over to a resonance path formed by the closed circuit configured of heating coil 59, resonant capacitor 60, first switching element 55 or first diode 56, and second smoothing capacitor 62 illustrated in part (a) of FIG. 5. Thus, a resonance current flows through the resonance path including the first switching element 55. At that time, drive period T1 of the drive signal output to the gate of first switching element 55 is set to a period similar (including identical) to drive period T2 of second switching element 57, for example, about 24 μs. Therefore, similarly to a case where second switching element 57 conducts, a resonance current flows through the resonance path including first switching element 55 at a cycle which is about 2/3 of drive period T1 (for example, 16 μs).

As a result of the above operation, the waveform of current IL flowing through heating coil 59 becomes the waveform illustrated in part (f) of FIG. 5. At that time, drive cycle T0 of each of first switching element 55 and second switching element 57 is a sum of drive periods T1, T2 and rest period (t2−t1=d1). Therefore, a cycle of a resonance current which is current IL flowing through heating coil 59 is about three times longer than the drive cycle of each of first switching element 55 and second switching element 57. Specifically, when a drive frequency (1/T0) of each of first switching element 55 and second switching element 57 is about 20 kHz, a frequency of the resonance current corresponding to current IL flowing through heating coil 59 is about 60 kHz.

However, in a configuration of the conventional induction heating device, following problems occur when the number of turns of the heating coil is decreased in order to reduce thickness and a manufacturing cost of the heating coil.

First, when the number of turns of the heating coil is decreased, an amount of a current flowing through the heating coil needs to be increased in order to obtain power identical to power obtained when the number of turns is not decreased. At that time, since an amount of a current flowing through each switching element is proportional to an amount of a current flowing through the heating coil, loss in each switching element increases, and an amount of heat generated increases. Therefore, in order to cool each switching element, a large-sized cooling component is required. Furthermore, an expensive component is required to improve cooling performance.

When a non-magnetic pot with low equivalent resistance, such as a pot made of aluminum, is induction-heated, the equivalent resistance needs to be increased by increasing the number of turns of the heating coil or by increasing the drive frequency. However, an increase in equivalent resistance is limited by a shape of a heating coil unit or a frequency band to be used. Therefore, it is difficult to achieve compatibility between reduction in the number of turns of the heating coil and loss reduction in the switching element.

### SUMMARY

The present disclosure provides an induction heating device capable of efficiently heating a pot made of aluminum by suppressing an increase in a current flowing through a switching element even when a number of turns of a heating coil is small.

That is, the induction heating device of the present disclosure includes an inverter. The inverter includes a switching element, a reverse conducting element connected in parallel to the switching element, and a resonant circuit including a heating coil and an object to be heated. The inverter supplies power to the resonant circuit when input of a DC voltage makes the switching element conductive. The resonant circuit includes a first resonant circuit configured with the heating coil and a first resonant capacitor connected in series to the heating coil, a second resonant circuit configured with the first resonant circuit and a second resonant capacitor connected in parallel to the first resonant circuit, and a resonance choke coil connected in series to the second resonant circuit. The resonant circuit is configured so that impedance of the heating coil and the first resonant capacitor is set to be close to impedance of the second resonant capacitor, at a frequency of a current flowing through the heating coil.

According to this configuration, even when a number of turns of the heating coil is reduced, resonance makes it possible to make a large current flow through the heating coil. Therefore, a non-magnetic pot made of aluminum or the like can be induction-heated at sufficiently large output. In addition, the resonance choke coil suppresses a current flowing through the switching element. Thus, loss generated at the switching element can be greatly reduced. This configuration can thus realize the induction heating device in which a thickness of the heating coil can be reduce and a cooling configuration of the switching element can be simplified.

### BRIEF DESCRIPTION OF THE DRAWINGS

FIG. 1 is a circuit configuration diagram of an induction heating device according to an exemplary embodiment of the present disclosure;

FIG. 2 is a diagram illustrating operation waveforms of the induction heating device according to the exemplary embodiment;

FIG. 3A is a diagram illustrating a waveform of a current flowing through a heating coil, a waveform of a current flowing through a switching element, and a drive voltage waveform of the switching element, in each circuit configuration of a conventional induction heating device;

FIG. 3B is a diagram illustrating a waveform of a current flowing through a heating coil, a waveform of a current flowing through a switching element, and a drive voltage waveform of the switching element, in each circuit configuration of the induction heating device according to the exemplary embodiment;

FIG. 4 is a circuit configuration diagram of the conventional induction heating device; and

FIG. 5 is a diagram illustrating operation waveforms in the circuit configuration of the conventional induction heating device.

### DETAILED DESCRIPTION

An exemplary embodiment of the present disclosure will be described below with reference to the drawings. This exemplary embodiment does not intend to limit the present disclosure.

### Exemplary Embodiment

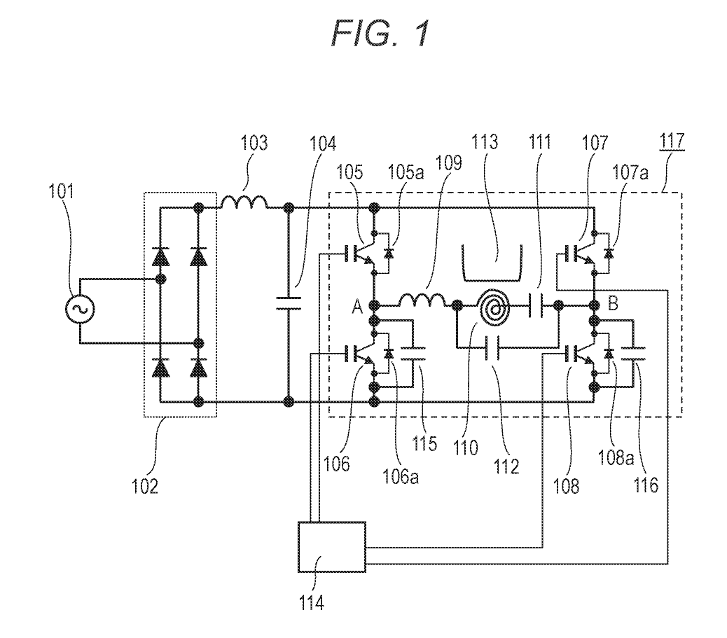

An induction heating device according an exemplary embodiment of the present disclosure will be described below with reference to FIG. 1.

FIG. 1 is a circuit configuration diagram of the induction heating device according to the exemplary embodiment.

As illustrated in FIG. 1, the induction heating device according to the exemplary embodiment is configured with rectifier circuit 102, smoothing choke coil 103, smoothing capacitor 104, inverter 117, controller 114, and the like. The induction heating device is connected to power source 101. Power source 101 is configured with a commercial AC power source and is connected to an input terminal of rectifier circuit 102. Rectifier circuit 102 is configured with, for example, a diode bridge, and rectifies an AC voltage input from power source 101. Smoothing choke coil 103 is connected in series to an output side of rectifier circuit 102. Smoothing capacitor 104 is connected in parallel to rectifier circuit 102 on an output side of smoothing choke coil 103.

As indicated by a dotted line in FIG. 1, inverter 117 is configured with first switching element 105, second switching element 106, third switching element 107, fourth switching element 108, resonance choke coil 109, heating coil 110, first resonant capacitor 111, second resonant capacitor 112, first snubber capacitor 115, second snubber capacitor 116, and the like.

Each of diode 105a, diode 106a, diode 107a, and diode 108a configures a reverse conducting element. Diode 105a is connected between a collector and an emitter of first switching element 105. Diode 106a is connected between a collector and an emitter of second switching element 106. Diode 107a is connected between a collector and an emitter of third switching element 107. Diode 108a is connected between a collector and an emitter of fourth switching element 108.

Resonance choke coil 109, heating coil 110, and first resonant capacitor 111 are connected in series between connecting point A between first switching element 105 and second switching element 106, and connecting point B between third switching element 107 and fourth switching element 108. Second resonant capacitor 112 is connected in parallel to heating coil 110 and first resonant capacitor 111 that are connected in series.

A first resonant circuit is configured with heating coil 110 and first resonant capacitor 111 that are connected in series. In addition, a second resonant circuit is configured with the first resonant circuit and second resonant capacitor 112 that are connected in parallel. The second resonant circuit is connected in series to resonance choke coil 109.

A top plate (not illustrated) is configured with, for example, an insulator made of a heat-resistant ceramic, and is disposed on a top of heating coil 110. Object 113 to be heated such as a pot is placed on the top plate so as to face heating coil 110 across the top plate.

Controller 114 controls each of first switching element 105, second switching element 106, third switching element 107, and fourth switching element 108 which configure inverter 117. First snubber capacitor 115 is connected between the collector and the emitter of second switching element 106. Similarly, second snubber capacitor 116 is connected between the collector and the emitter of fourth switching element 108.

A DC voltage is input to inverter 117 via smoothing choke coil 103. Power is supplied to the first resonant circuit and the second resonant circuit by causing each of first switching element 105, second switching element 106, third switching element 107, and fourth switching element 108 of inverter 117 to conduct. At that time, capacitance of second resonant capacitor 112 is set to be, for example, three times greater than capacitance of first resonant capacitor 111. Thus, second resonant capacitor 112 can be considered as a high-frequency power source.

In addition, in the exemplary embodiment, an impedance value of the first resonant circuit configured with heating coil 110 and first resonant capacitor 111 is set to be close to an impedance value of second resonant capacitor 112, at a frequency of a high-frequency current flowing through heating coil 110. Thus, a large current can be made to flow through second resonant circuit configured with a closed loop which is formed by second resonant capacitor 112, heating coil 110, and first resonant capacitor 111.

Note that when the impedance value of first resonant circuit is not close to the impedance value of second resonant capacitor 112, a current flows through not only the closed loop formed by second resonant capacitor 112, heating coil 110, and first resonant capacitor 111 but also flows in a direction from second resonant capacitor 112 to resonance choke coil 109. Therefore, a current also flows in a path other than the closed loop formed by second resonant capacitor 112, heating coil 110, and first resonant capacitor 111. Therefore, the impedance value of the first resonant circuit is set to be close to the impedance value of second resonant capacitor 112. This can make a large current flow through only the closed loop which is formed by second resonant capacitor 112, heating coil 110, and first resonant capacitor 111.

Specifically, when the impedance value of first resonant circuit configured with heating coil 110 and first resonant capacitor 111 is set to, for example, 10 ohms, capacitance of second resonant capacitor 112 is set such that the impedance value of second resonant capacitor 112 ranges from 7 ohms to 13 ohms. This can make a large current stably and efficiently flow through the closed loop formed by second resonant capacitor 112, heating coil 110, and first resonant capacitor 111.

That is, the impedance value of second resonant capacitor 112 is set to be close to the impedance value of the first resonant circuit (for example, within ±30%). Thus, a current flowing from second resonant capacitor 112 to resonance choke coil 109 can be significantly suppressed. This can make a large current flow through the closed loop formed by second resonant capacitor 112, heating coil 110, and first resonant capacitor 111.

The induction heating device is configured as described above.

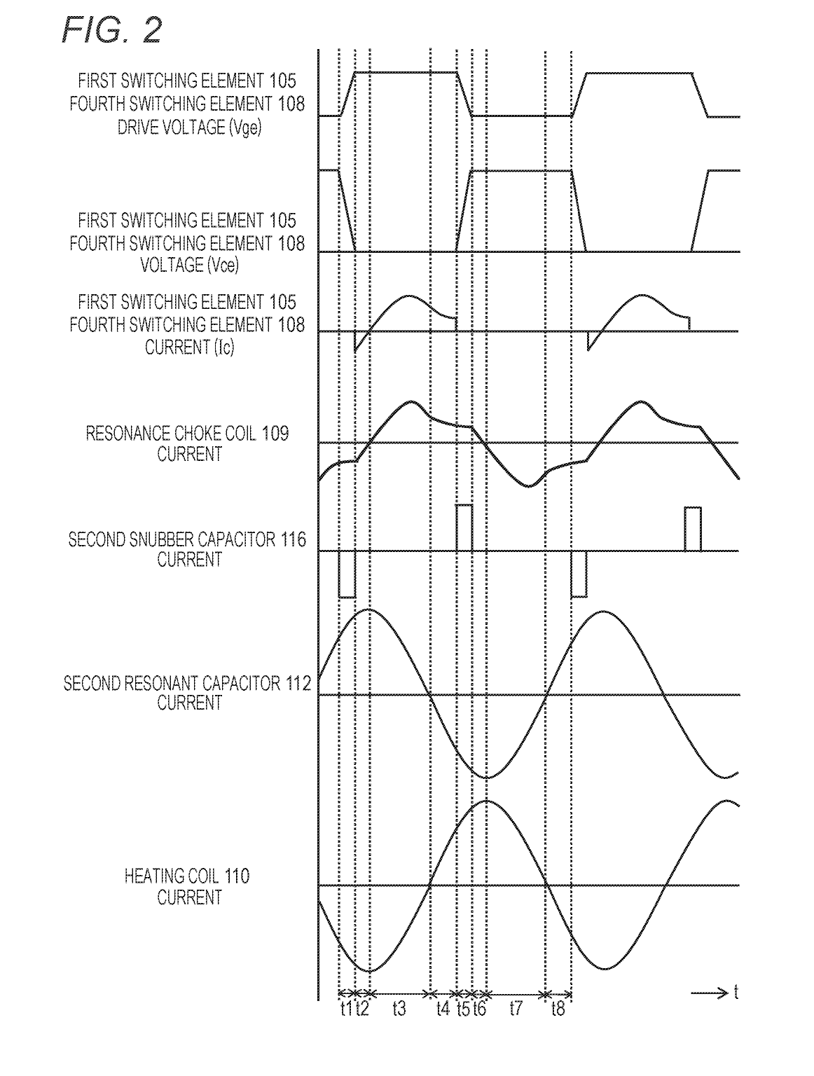

Operation and effects of the induction heating device will be described below with reference to FIG. 2 together with FIG. 1.

FIG. 2 is a diagram illustrating operation waveforms of the induction heating device according to the exemplary embodiment.

Specifically, FIG. 2 is a diagram illustrating voltage and current waveforms (Vge, Vce, Ic) of each of first switching element 105 and fourth switching element 108, a current waveform of resonance choke coil 109, a current waveform of second snubber capacitor 116, a current waveform of second resonant capacitor 112, and a current waveform of heating coil 110, when object 113 to be heated, which is a pot made of aluminum, is induction-heated. Note that drive voltage Vge is a voltage applied between a gate and the emitter of each switching element, and voltage Vce is a voltage between the collector and the emitter of each switching element.

As illustrated in FIGS. 1 and 2, first, controller 114 causes first switching element 105 and fourth switching element 108 of inverter 117 to be turned on. At that time, controller 114 causes second switching element 106 and third switching element 107 of inverter 117 to be turned off.

Next, similarly to the above, controller 114 causes first switching element 105 and fourth switching element 108 to be turned off. At that time, controller 114 causes second switching element 106 and third switching element 107 to be turned on. Thus, a resonance current at a resonance frequency is supplied to heating coil 110 of inverter 117. The resonance frequency is determined depending on heating coil 110, first resonant capacitor 111, second resonant capacitor 112, and object 113 to be heated.

A resonance current supplied to heating coil 110 generates a high-frequency magnetic field, and thus object 113 to be heated is induction-heated. At that time, controller 114 drives first switching element 105, second switching element 106, third switching element 107, and fourth switching element 108 at a drive frequency lower than the resonance frequency determined depending on heating coil 110, first resonant capacitor 111, second resonant capacitor 112, and object 113 to be heated. Thus, loss in each switching element can be suppressed more effectively than loss in each switching element caused when each switching element is driven at a drive frequency higher than the resonance frequency.

As described above, the operation and effects of the induction heating device are achieved.

An operation of inverter 117 will be specifically described below while a path through which a resonance current flows is being focused on.

First, period t1 in FIG. 2 is timing when first switching element 105 and fourth switching element 108 are turned on, and second switching element 106 and third switching element 107 are turned off. At that time, after second switching element 106 and third switching element 107 are turned off, a current flowing through a path starts to flow into first snubber capacitor 115. Thus, electrostatic energy is stored in first snubber capacitor 115. In contrast, second snubber capacitor 116 discharges stored electrostatic energy.

At that time, currents flowing through two loops are generated at heating coil 110. In a first loop, the current flows through second resonant capacitor 112, first resonant capacitor 111, and heating coil 110. In a second loop, the current flows through second snubber capacitor 116, first resonant capacitor 111, heating coil 110, resonance choke coil 109, and first snubber capacitor 115.

Next, period t2 is a period until magnetic energy stored in resonance choke coil 109 is discharged after electrostatic energy has been stored in first snubber capacitor 115, in a state where first switching element 105 and fourth switching element 108 are turned on. At that time, the current does not flow through first snubber capacitor 115. This situation generates a loop of a current flowing through diode 105a connected in parallel to first switching element 105, and through diode 108a connected in parallel to fourth switching element 108.

At that time, currents flowing through two loops are generated at heating coil 110. In a first loop, the current flows through second resonant capacitor 112, first resonant capacitor 111, and heating coil 110. In a second loop, the current flows through diode 108a of fourth switching element 108, first resonant capacitor 111, heating coil 110, resonance choke coil 109, diode 105a of first switching element 105, and smoothing capacitor 104.

Next, period t3 is a period in which resonance choke coil 109 is charged after magnetic energy of resonance choke coil 109 has been discharged. During period t3, a soft-switching operation state is established. That is, first switching element 105 and fourth switching element 108 are turned on. Thus, loss upon switching of first switching element 105 and fourth switching element 108 can be reduced.

At that time, a current is generated at heating coil 110, and the current flows through one first loop configured with second resonant capacitor 112, heating coil 110, and first resonant capacitor 111.

Next, period t4 is a period in which a voltage is applied to heating coil 110 and first resonant capacitor 111 in a direction reverse to a direction in which a voltage is applied in period t3. Therefore, electric charges stored in second resonant capacitor 112 are discharged. In contrast, since resonance choke coil 109 is charged in period t4, a current flows through resonance choke coil 109 in a direction identical to the direction in which a current flows in period t3.

At that time, currents flowing through two loops are generated at heating coil 110. In a first loop, the current flows through second resonant capacitor 112, heating coil 110, and first resonant capacitor 111. In a second loop, the current flows through first switching element 105, resonance choke coil 109, heating coil 110, first resonant capacitor 111, fourth switching element 108, and smoothing capacitor 104.

On and after period t5, first switching element 105 and fourth switching element 108 are turned off, and second switching element 106 and third switching element 107 are turned on. An operation similar to the operation in the above periods t1 to t4 is performed until period t8. Therefore, a description of the operation in periods t5 to t8 will be omitted.

That is, since the operations in periods t1 to t4 and periods t5 to t8 are repeated, a current is supplied to heating coil 110 and a high-frequency magnetic field is generated. The generated high-frequency magnetic field causes eddy currents to be generated in object 113 to be heated. Thus, object 113 to be heated is induction-heated.

As described above, the induction heating device according to the exemplary embodiment connects resonance choke coil 109 to connecting point A between first switching element 105 and second switching element 106. Then, heating coil 110, first resonant capacitor 111, and second resonant capacitor 112 are connected to an output terminal of resonance choke coil 109. Here, disposition of resonance choke coil 109 increases input impedance at high-frequency driving from a viewpoint of each of first switching element 105 to fourth switching element 108. Thus, a current flowing through each of first switching element 105 to fourth switching element 108 can be suppressed. Furthermore, suppression of a current enables reduction in loss upon switching of each of first switching element 105 to fourth switching element 108.

In addition, a large current can be made to flow through a loop of a closed circuit which is formed by second resonant capacitor 112, heating coil 110, and first resonant capacitor 111. Therefore, a resonance operation makes it possible to make a current flow through heating coil 110. The current is large enough to sufficiently heat object 113 to be heated. Therefore, object 113 to be heated which is configured with a non-magnetic pot made of aluminum or the like can be induction-heated at sufficiently large output.

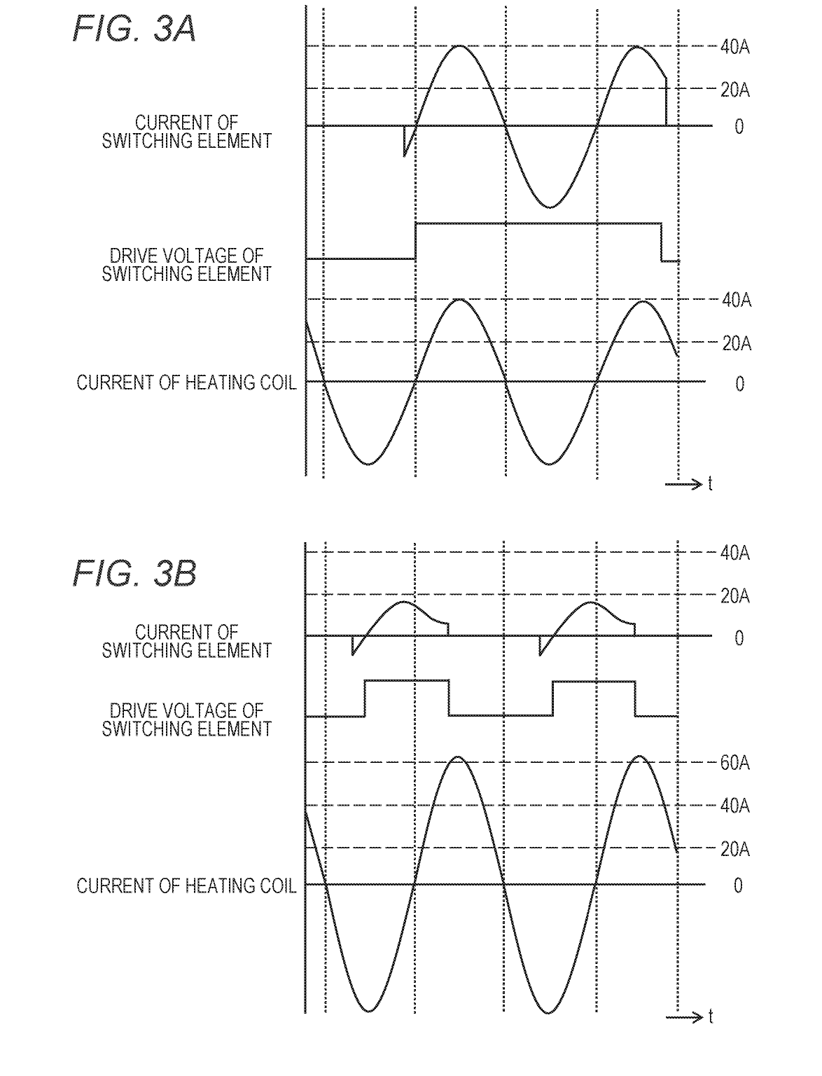

Amounts of currents flowing through heating coil 110 and each of first switching element 105 to fourth switching element 108 will be described below with reference to FIGS. 3A and 3B, in comparison with amounts of currents flowing through the heating coil and the switching element in the conventional induction heating device.

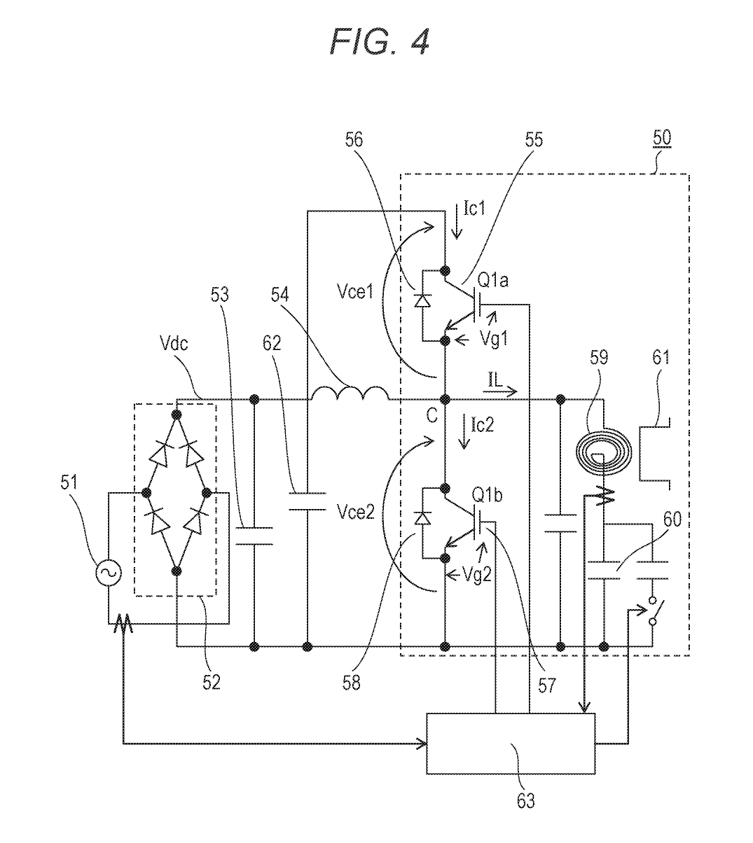

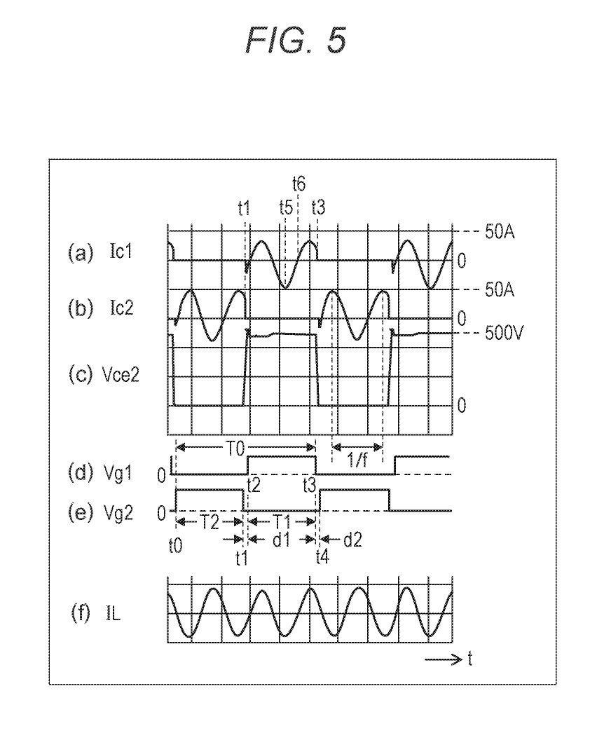

FIG. 3A is a diagram illustrating waveforms of currents flowing through the heating coil and the switching element of the conventional induction heating device illustrated in FIG. 4, and a drive voltage waveform of the switching element. FIG. 3B is a diagram illustrating a waveform of currents flowing through the heating coil and the switching element of the induction heating device according to the exemplary embodiment, and a drive voltage waveform of the switching element.

Specifically, FIG. 3A illustrates the waveform of a current flowing through the heating coil 59 with, for example, 40 turns, and a waveform of a current flowing through each of first switching element 55 and second switching element 57 and a drive voltage waveform of each switching element, in a circuit configuration illustrated in FIG. 4. FIG. 3B illustrates a waveform of a current flowing through heating coil 110 with, for example, 30 turns, and a waveform of a current flowing through each of first switching element 105 to fourth switching element 108 and a drive voltage waveform of each switching element, in a circuit configuration according to the exemplary embodiment. Here, a drive voltage frequency of each of the first and second switching elements illustrated in FIG. 3 A is, for example, 30 kHz, and a frequency of a resonance current flowing through the heating coil is 90 kHz, which is three times higher than the frequency of the drive voltage of the switching element. The reason for this is as follows. First, when an object to be heated is made of a magnetic material such as iron and the switching element is switched over from an ON-state to an OFF-state, a current flowing through the heating coil instantly attenuates. In contrast, when the object to be heated is made of a non-magnetic material such as aluminum, since a resistance is small, a current flowing through the heating coil does not instantly attenuate. Therefore, in a case of the circuit configuration illustrated in FIG. 4, the above described characteristic is utilized to enable the frequency of a resonance current flowing through the heating coil to be set to 90 kHz even when the drive voltage frequency of the switching element is set to 30 kHz.

In contrast, both a drive voltage frequency of each of the first to fourth switching elements illustrated in FIG. 3B and a frequency of a resonance current flowing through the heating coil illustrated in FIG. 3B are 90 kHz. Therefore, as described above, a large current can be made to flow through the loop of the closed circuit which is formed by second resonant capacitor 112, heating coil 110, and first resonant capacitor 111.

That is, in a case of a conventional circuit configuration, as illustrated in FIG. 3A, the switching element is driven by a drive voltage with a frequency of 30 kHz. As a result, a number of switching times of the switching element is reduced, and thus loss upon switching is reduced. At that time, in an ON period of each of the first and second switching elements, a current flows through each of the first and second switching elements at a frequency similar to a frequency of a current flowing through the heating coil.

In contrast, in a case of a circuit configuration of the exemplary embodiment, the number of turns of the heating coil is reduced. Therefore, in order to obtain heating quantity similar to heating quantity obtained with a conventional induction heating cooker, an amount of a current flowing through the heating coil increases.

That is, when the number of turns of the heating coil in the conventional circuit configuration is reduced similarly to the exemplary embodiment, an amount of a current flowing through each of the first and second switching elements increases. Thus, loss upon switching of each of the first and second switching elements, and loss in each switching element during the ON period increase.

However, in the circuit configuration of the exemplary embodiment, even when the number of turns of the heating coil is reduced, the amount of a current flowing through the heating coil can be increased while a current flowing through each of the first to fourth switching elements is being reduced, as illustrated in FIG. 3B. Thus, even when each of the first to fourth switching elements is driven by drive voltage with a frequency of 90 kHz, loss upon switching of each switching element, and loss in each switching element during the ON period can be reduced. Furthermore, even when the number of turns of the heating coil is reduced, a large current can be made to flow through the heating coil. As a result, an induction heating device which enables reduction in a thickness of the heating coil and reduction in a manufacturing cost of the heating coil can be realized.

In the induction heating device according to the exemplary embodiment, even when the number of turns of the heating coil is reduced, a large current can be made to flow through the heating coil. Therefore, an object to be heated such as a non-magnetic pot can be effectively heated.

In addition, each of the first to fourth switching elements can be operated by a small current. Thus, an increase in loss upon switching of each of the first to fourth switching elements can be suppressed.

This makes it possible to reduce loss in each of the first to fourth switching elements upon switching, as well as to reduce the thickness of the heating coil. Therefore, a cooling configuration can be simplified and a size of the circuit configuration can be reduced.

As described above, the induction heating device of the present disclosure includes an inverter. The inverter includes a switching element, a reverse conducting element connected in parallel to the switching element, and a resonant circuit including a heating coil and an object to be heated. The inverter supplies power to the resonant circuit when input of a DC voltage makes the switching element conductive. The resonant circuit includes a first resonant circuit configured with the heating coil and a first resonant capacitor connected in series to the heating coil, a second resonant circuit configured with the first resonant circuit and a second resonant capacitor connected in parallel to the first resonant circuit, and a resonance choke coil connected in series to the second resonant circuit. The resonant circuit is configured so that impedance of the heating coil and the first resonant capacitor is set to be close to impedance of the second resonant circuit, at a frequency of a current flowing through the heating coil.

Thus, even when the number of turns of the heating coil is small, a current flowing through the switching element can be suppressed while a large current is being fed through the heating coil. As a result, an object to be heated, such as a pot made of aluminum can be efficiently induction-heated.

In addition, in the induction heating device of the present disclosure, impedance of the second resonant capacitor may be set to be within ±30% of impedance of the heating coil and the first resonant capacitor. Thus, it is possible to suppress a current flowing through the switching element can be suppressed so that the switching element can be sufficiently cooled while the number of turns of the heating coil is reduced.

What is claimed is:

1. An induction heating device comprising:
an inverter including
a switching element,
a reverse conducting element that is connected in parallel to the switching element, and
a resonant circuit that includes a heating coil and an object to be heated,
the inverter being configured to supply power to the resonant circuit when input of a direct-current (DC) voltage makes the switching element conductive,
wherein the resonant circuit includes a first resonant circuit configured with the heating coil and a first resonant capacitor which is connected in series to the heating coil, a second resonant circuit configured with the first resonant circuit and a second resonant capacitor which is connected in parallel to the first resonant circuit, and a resonance choke coil which is connected in series to the second resonant circuit, and
the resonant circuit is configured so that impedance of the heating coil and the first resonant capacitor is set to be close to impedance of the second resonant capacitor, at a frequency of a current flowing through the heating coil.

2. The induction heating device according to claim 1, wherein the impedance of the second resonant capacitor is set to be within ±30% of the impedance of the heating coil and the first resonant capacitor.
